(19) United States
(12) Patent Application Publication
(10) Pub. No.: US 2019/0045117 A1
(43) Pub. Date: Feb. 7, 2019

(54) PANORAMIC DISPLAY SCREEN ASSEMBLY WITH INTEGRAL VENTILATION PASSAGEWAYS

(71) Applicant: FORD GLOBAL TECHNOLOGIES, LLC, Dearborn, MI (US)

(72) Inventors: Clay Wesley Maranville, Ypsilanti, MI (US); Kevin VanNieulande, Fraser, MI (US); Jeffery Norbert Conley, Belleville, MI (US); James George Gebbie, Rochester Hills, MI (US)

(21) Appl. No.: 15/668,313

(22) Filed: Aug. 3, 2017

(51) Int. Cl. H04N 5/232; B60H 1/00; G02B 27/01; B60R 1/00

(52) U.S. Cl. CPC H04N 5/23238; B60H 1/00021; G02B 27/0149; B60R 2300/205; B60R 1/001; B60R 2300/207; G02B 27/0101

(57) ABSTRACT

A display screen assembly and a motor vehicle assembly are provided. The display screen assembly includes an elongated body extending across a base of a windshield and a first ventilation passage, in the elongated body, configured to distribute air from an HVAC system across the windshield. The motor vehicle assembly, the windshield, an instrument panel and the display screen assembly extending across a base of the windshield and atop of the instrument panel.

### TECHNICAL FIELD

This document relates generally to the motor vehicle equipment field and, more particularly, to a panoramic display screen assembly which extends fully across a motor vehicle at the interface of the windshield and the instrument panel. The display screen assembly includes at least one integral ventilation passageway for distributing air from an HVAC system across the windshield and/or the front sidelights or front door windows of the motor vehicle.

### BACKGROUND

This document relates to a panoramic display screen mounted where the instrument panel meets the windshield of the motor vehicle. The panoramic display screen extends fully across the entire width of the windshield and instrument panel of the motor vehicle. Further, the panoramic display screen includes a least one integral ventilation passageway configured to distribute air from an HVAC system across the windshield and in some embodiments also to sidelight or front door window demisters provided in the A-pillars of the motor vehicle.

### SUMMARY

In accordance with the benefits and advantages disclosed herein, a panoramic display screen assembly is provided. That panoramic display screen assembly comprises an elongated body that extends across a base of a motor vehicle windshield at the top of the instrument panel. The display screen assembly further includes a first ventilation passageway in the elongated body that is configured to distribute air from a heating, ventilation and air conditioning (HVAC) system of the motor vehicle across the windshield.

The elongated body may include a display screen, a close out panel oriented motor vehicle forward toward the windshield, and a support substrate packaged between the display screen and the close out panel. The first ventilation passageway may be at least partially formed in the support substrate.

The first ventilation passageway may further include a first inlet and a first outlet located intermediate a first end and a second end of the elongated body. Further, the first passageway may increase in cross sectional area from the first inlet to the first outlet.

The display screen assembly may further include a second passageway having a second inlet and a second outlet. The second outlet may be located at the first end of the elongated body. In addition, the display screen assembly may further include a third passageway having a third inlet and a third outlet. The third outlet may be located at the second end of the elongated body.

In accordance with an additional aspect, a motor vehicle assembly is provided comprising a windshield, an instrument panel and a display screen. That display screen extends across a base of the windshield and atop the instrument panel. The display screen includes an elongated body and a first ventilation passageway, in the elongated body, configured to distribute air from an HVAC system across the windshield.

The elongated body may further include a display screen, a close out panel oriented motor vehicle forward toward the windshield and a support substrate. The support substrate is provided between the display screen and the close out panel.

The first ventilation passageway may be at least partially formed in the support substrate. Further, the first ventilation passageway may include a first inlet and a first outlet located intermediate a first end and a second end of the elongated body. Further, the first passageway may increase in cross sectional area from the first inlet to the first outlet.

The motor vehicle assembly may further include a second passageway having a second inlet and a second outlet. The second outlet may be located at the first end of the elongated body. In addition, the motor vehicle assembly may further include a third passageway having a third inlet and a third outlet. The third outlet may be located at the second end of the elongated body.

The instrument panel may include a first HVAC outlet in communication with the first inlet, a second HVAC outlet in communication with the second inlet and a third HVAC outlet in communication with the third inlet. In addition, the motor vehicle assembly may further include a first demister in a first A-pillar adjacent the windshield and a second demister in a second A-pillar adjacent the windshield. The first demister may be provided in communication with the second outlet while the second demister may be provided in communication with the third outlet.

A method of clearing a windshield of fog or ice above a full width display screen is also provided. That method may be described as comprising the steps of (a) directing conditioned air from an HVAC system to a first HVAC outlet provided in an instrument panel beneath the full width display screen and (b) directing the conditioned air from the first HVAC outlet to an air distribution passageway behind a central portion of the full width display screen onto the windshield.

In addition, the method may include the steps of directing the conditioned air from the HVAC system to a second HVAC outlet provided in the instrument panel beneath the full width display screen and directing the conditioned air from the second HVAC outlet to a first demister passageway behind the first end portion of the full width display screen and through a first demister in a first A-pillar adjacent the windshield. Still further, the method may include the steps of directing the conditioned air from the HVAC system to a third HVAC outlet provided in the instrument panel beneath the full width display screen and directing the conditioned air from the third HVAC outlet to a second demister passageway behind a second end portion of the full width display screen and through a second demister in a second A-pillar adjacent the windshield.

In the following description, there are shown and described several preferred embodiments of the display screen assembly, the motor vehicle assembly and the related method of clearing a windshield of fog or ice above a full width display screen. As it should be realized, the display screen assembly, motor vehicle assembly and method are capable of other, different embodiments and their several details are capable of modification in various, obvious aspects all without departing from the display screen assembly, motor vehicle assembly and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the display screen assembly, the motor vehicle assembly and the related method and together with the description serve to explain certain principles thereof.

FIG. 1 is a perspective view of an interior of a motor vehicle equipped with a display screen assembly.

FIG. 2 is a schematic illustration of a motor vehicle assembly including a windshield, an instrument panel and the display screen as illustrated in FIGS. 3a-3c.

FIG. 3a is a detailed perspective view of the display screen assembly from the display screen side.

FIG. 3b is a perspective view illustrating the display screen assembly of FIG. 2a from the close out side.

FIG. 3c is a perspective view identical to the view of FIG. 2b but with the close out panel removed to illustrate the support substrate that is packaged between the display screen and the close out panel of the display screen assembly.

FIG. 4 is a schematic illustration of an alternative embodiment of the motor vehicle assembly incorporating a modified display screen assembly.

FIGS. 5a and 5b illustrate just some of the information and data that may be displayed on the display screen of the display screen assembly.

Reference will now be made in detail to the present preferred embodiments of the display screen assembly, the motor vehicle assembly and the related method of clearing a windshield of fog or ice above a full width display screen, examples of which are illustrated in the accompanying drawing figures.

### DETAILED DESCRIPTION

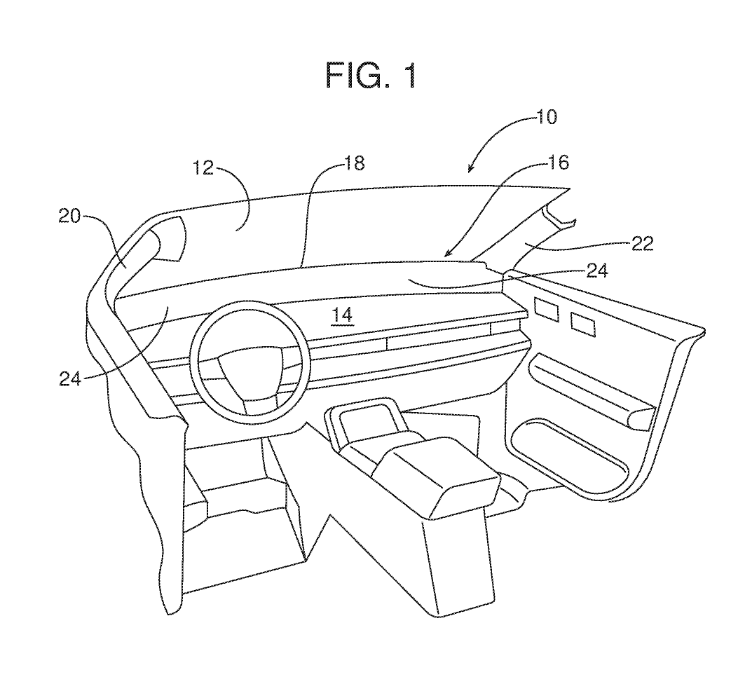

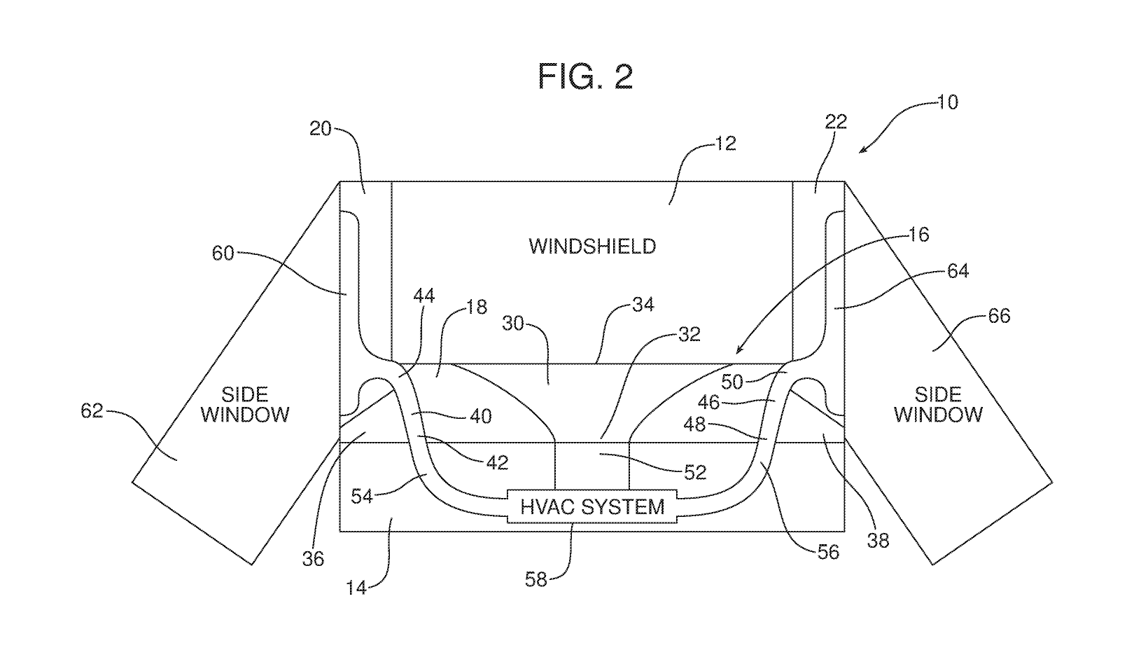

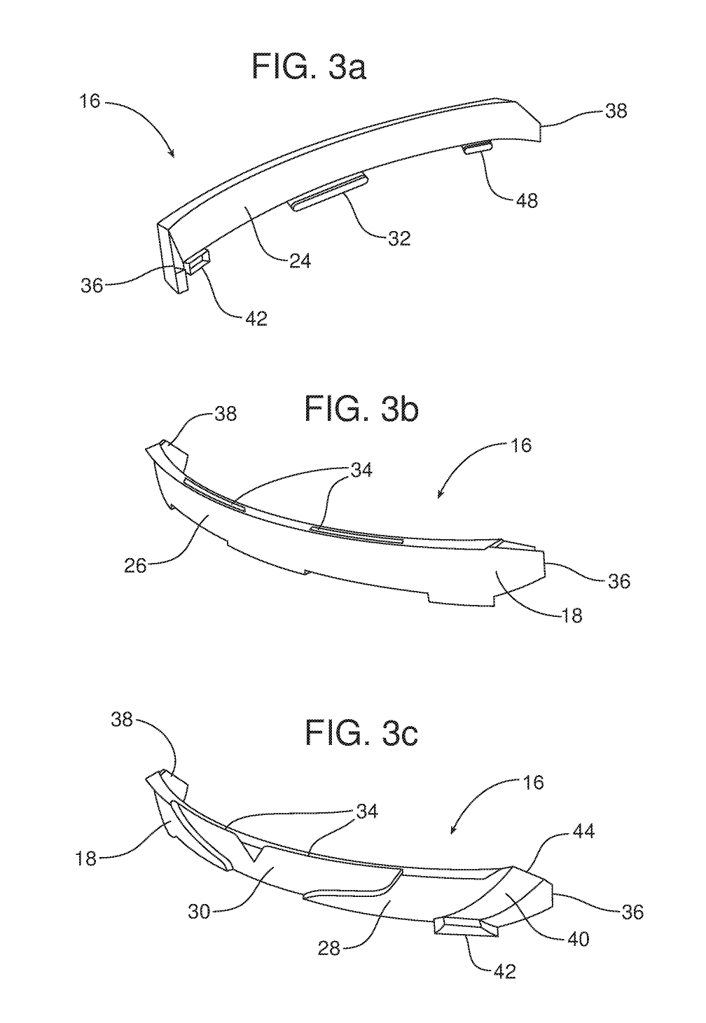

Reference is now made to FIGS. 1 and 2 illustrating a new and improved motor vehicle assembly 10 including a windshield 12, an instrument panel 14 and a new and improved display screen assembly generally designated by reference numeral 16. That display screen assembly 16 is illustrated in detail in FIGS. 3a-3c.

In the embodiment illustrated in FIGS. 1-3c, the display screen assembly 16 includes an elongated body 18 that extends vitally across the entire base of the windshield 12 between the first A-pillar 20 and the second, opposite A-pillar 22 at the top of the instrument panel 14. In one possible embodiment, the top of the instrument panel 14 has been lowered between about 80 and about 150 mm in height compared to a standard instrument panel in order to accommodate the display screen assembly 16 of similar height.

As best illustrated in FIGS. 1-3c, the elongated body 18 of the display screen assembly 16 includes a panoramic display screen 24 that extends from below the first A-pillar 20 all the way across the base of the windshield 12 and top of the instrument panel 14 to below the second A-pillar 22. As will be described in greater detail below, various information may be displayed on the panoramic display screen 24 across the entire width of the display screen. The display screen 24 may be a liquid crystal display (LCD), an organic light emitting diode (OLED) display or other appropriate type useful for the intended purpose of displaying information in a motor vehicle.

The elongated body 18 includes a close out panel 26 oriented motor vehicle forward toward the windshield 12 so as to provide a cosmetic appearance when viewed through the windshield at the front of the motor vehicle. Further, the elongated body 18 includes a support substrate 28 packaged between the display screen 24 and the close out panel 26. Both the close out panel 26 and the support substrate 28 may be molded from appropriate materials such as plastic resins or reinforced composite materials.

As further illustrated in FIGS. 2 and 3a-3c, a first ventilation passageway 30 is provided in the elongated body 18 and configured to distribute air from an HVAC of the motor vehicle across the windshield 12. As clearly illustrated in FIG. 3c, in the illustrated embodiment the first ventilation passageway 30 is at least partially formed in the support substrate 28 and may be closed on the open side by the close out panel 26.

As illustrated, the first ventilation passageway 30 includes a first inlet 32 and a first outlet 34 located intermediate a first end 36 of the display screen assembly 16 at the first A-pillar 20 and a second end 38 of the display screen assembly at the second A-pillar 22. In the illustrated embodiment, the first ventilation passageway 30 increases in cross sectional area from the first inlet 32 to the first outlet 34 in order to ensure distribution of conditioned air across the inner surface of the windshield 12.

As further illustrated in FIGS. 2 and 3c, the display screen assembly 16 also includes a second passageway 40 having a second inlet 42 and a second outlet 44. The second outlet 44 is located at the first end 36 of the display screen assembly 16 adjacent the first A-pillar 20. As illustrated in FIG. 2, the display screen assembly 16 also includes a third passageway 46 having a third inlet 48 and a third outlet 50. The third outlet 50 is located at the second end 38 of the display screen assembly 16 adjacent the second A-pillar 22.

As further illustrated in FIG. 2, the instrument panel 14 includes a first HVAC outlet 52 in communication with the first inlet 32, a second HVAC outlet 54 in the instrument panel in communication with the second inlet 42 and a third HVAC outlet 56 in communication with the third inlet 48. As should be appreciated, the first HVAC outlet 52 delivers or directs conditioned air from the HVAC system 58 into the first ventilation passageway 30, the second HVAC outlet 54 directs conditioned air from the HVAC system into the second ventilation passageway 40 and the third HVAC outlet 56 directs conditioned air from the HVAC system into the third ventilation passageway 46.

Conditioned air passing through the first ventilation passageway 30 is discharged through the first outlet 34 across the interior surface of the windshield 12 for defogging or defrosting the windshield. Conditioned air passing through the second ventilation passageway 40 is delivered to a first demister 60 in the first A-pillar 20 through the second outlet 44. The first demister 60 functions to distribute that air across the first side light or side window 62 where that air functions to defog or defrost that window. Similarly, the third ventilation passageway 46 serves to deliver conditioned air to a second demister 64 in the second A-pillar 22 through the third outlet 50. The second demister 64 functions to distribute that conditioned air across the inner surface of the second sidelight or side window 66 thereby serving to defog or defrost that window.

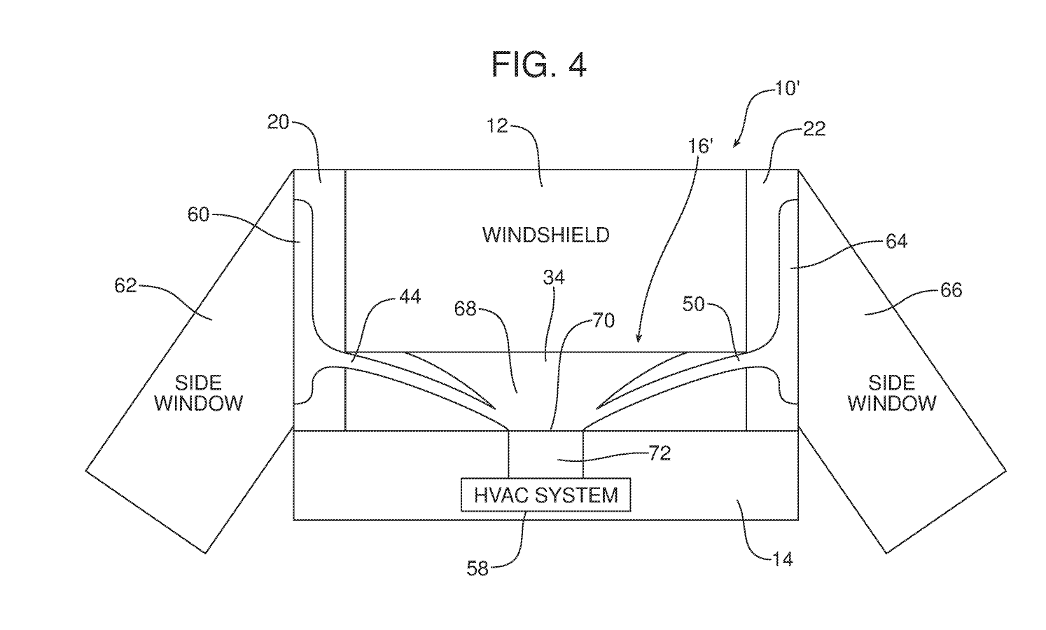

Reference is now made to FIG. 4 illustrating an alternative embodiment of motor vehicle assembly 10′ which incorporates an alternative embodiment of display screen assembly 16′. The display screen assembly 16′ illustrated in FIG. 4 differs from the display screen assembly 16 illustrated in FIGS. 2 and 3c of the first embodiment by incorporating a single branched ventilation passageway 68 at least partially formed in the support substrate 28 behind the close out. The single ventilation passageway 68 includes a single inlet 70 in communication with a single HVAC outlet 72 in the instrument panel 14. Conditioned air received from the HVAC system 58 through the HVAC outlet 72 is directed by the single branched ventilation passageway 68 to a first outlet 34 for distributing air across the interior surface of the windshield 12, a second outlet 44 for delivering conditioned air to the first demister 60 in the first A-pillar 20 and a third outlet 50 for delivering conditioned air to the second demister 64 in the second A-pillar 22. As with the previous embodiment, conditioned air is distributed by the first demister 60 across the inner surface of the first side window 62 for defogging or defrosting that first side window. Similarly, conditioned air received by the second demister 64 is distributed across the interior surface of the second side window 66 to defog or defrost that second side window. Further, conditioned air received by the first outlet 34 is discharged across the interior surface of the windshield 12 for defrosting or defogging the windshield.

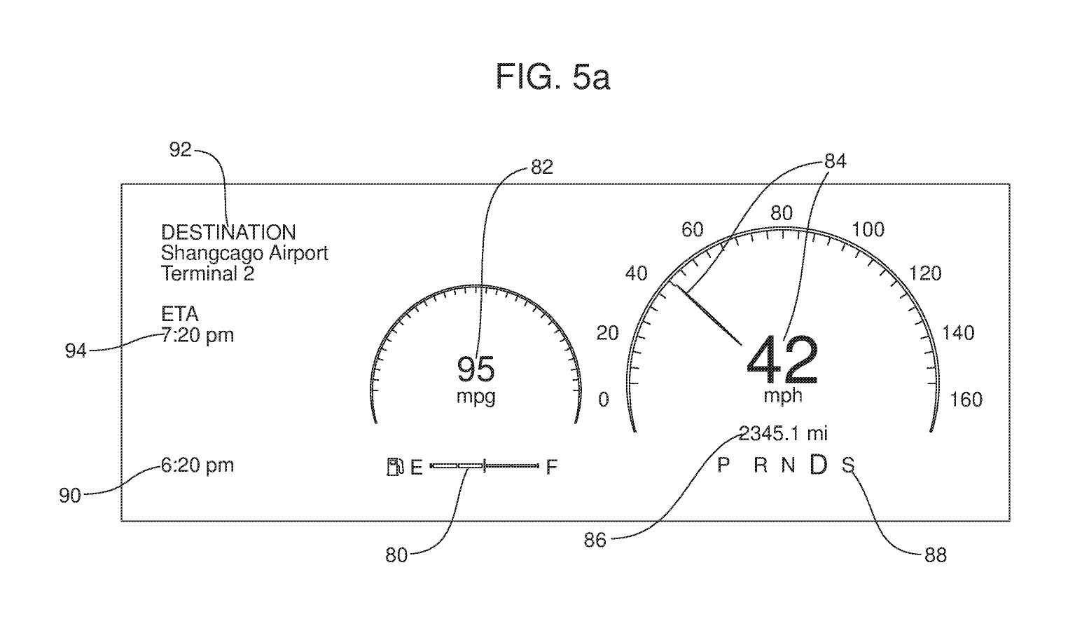

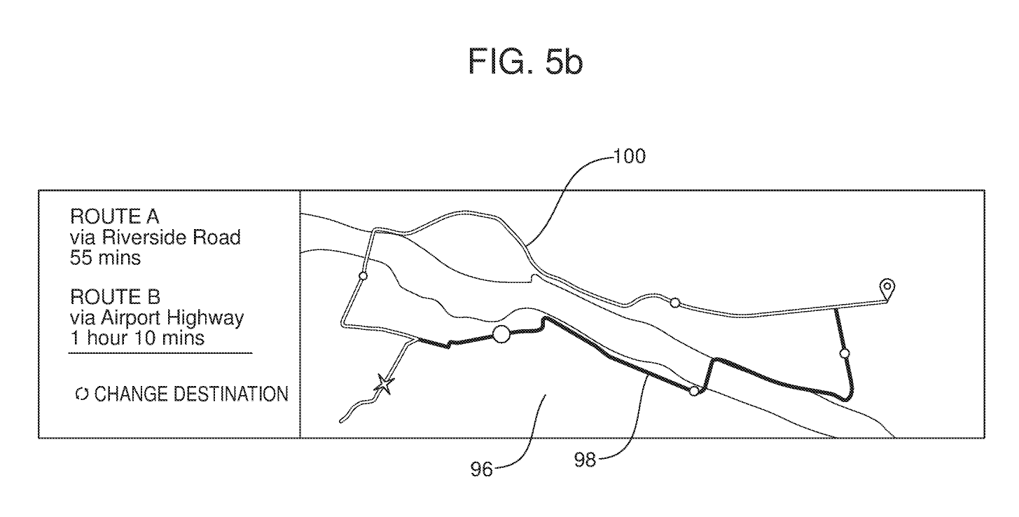

In either of the embodiments of the motor vehicle assembly 10, 10′ illustrated, respectively, in FIGS. 1-3c and 4, the panoramic display screen 24 may be utilized to display various types of motor vehicle operating data or other information across the entire width of the motor vehicle between the top of the instrument panel 14 and the base of the windshield 12 where it may be easily viewed by the motor vehicle driver and other passengers. For example, as illustrated in FIG. 5a, a portion of the panoramic display screen 24 displays the remaining fuel at 80, the miles per gallon at 82, the speed of the motor vehicle at 84, the mileage at 86 and the transmission status at 88. The current time is displayed at 90. The selected trip destination is displayed at 92 and the estimated time of arrival at that destination is displayed at 94.

As illustrated in FIG. 5b, a portion of the panoramic display screen 24 may display a map 96 to the destination. In the illustration, the map 96 displays two routes: “ROUTE B” shown at 98 and in use as well as alternative “ROUTE A” shown at 100 and not in use.

It should be appreciated that this or other information may be displayed as desired. In some embodiments, the display of information may be configured and customized by the motor vehicle operator.

As should be appreciated, the top of the panoramic display screen 24 and the display screen assembly 16 are positioned sufficiently low so as to not interfere with the visual field required by the driver to safely operate the motor vehicle.

Consistent with the above description, a method is provided of clearing a windshield 12 of fog or ice above a full width display screen 24 of the panoramic type extending fully across the base of the windshield between the A-pillars 20, 22 and along the top of the instrument panel 14. That method includes the step of directing conditioned air from an HVAC system 58 to a first HVAC outlet 52 provided in the instrument panel 14 beneath the full width display screen 24 and directing that conditioned air from the first HVAC outlet through a first ventilation passageway 30 behind a central portion of the full width display screen onto the windshield 12.

The method may further include the steps of directing the conditioned air from the HVAC system 58 to a second HVAC outlet 54 provided in the instrument panel 14 beneath the full width display screen 24 and directing that conditioned air from the second HVAC outlet through a second ventilation passageway 40 behind a first end 36 of the full width display screen 24 and then through the first demister 60 in a first A-pillar 20 adjacent the windshield. Still further, the method may include the steps of directing the conditioned air from the HVAC system 58 to a third HVAC outlet 56 provided in the instrument panel 14 beneath the full width display screen 24 and directing that conditioned air from the third HVAC outlet through a third ventilation passageway 46 behind a second end 38 of the full width display screen and then through the second demister 64 in a second A-pillar 22 adjacent the windshield.

The foregoing has been presented for purposes of illustration and description. It is not intended to be exhaustive or to limit the embodiments to the precise form disclosed. Obvious modifications and variations are possible in light of the above teachings. For example, in a fully autonomous motor vehicle, the panoramic display screen 24 may be configured to display videos, informational programming, entertainment programming or other desired materials from substantially any desired source including sources available over a wireless internet or other network connection. All such modifications and variations are within the scope of the appended claims when interpreted in accordance with the breadth to which they are fairly, legally and equitably entitled.

What is claimed:

1. A display screen assembly, comprising:
an elongated body extending across a base of a windshield; and
a first ventilation passageway, in said elongated body, configured to distribute air from an HVAC system across said windshield.

2. The display screen assembly of claim 1, wherein said elongated body includes a display screen, a close out panel and a support substrate between said display screen and said close out panel.

3. The display screen assembly of claim 2, wherein said first ventilation passageway is at least partially formed in said support substrate.

4. The display screen assembly of claim 3, wherein said first ventilation passageway includes a first inlet and a first outlet located intermediate a first end and a second end of said elongated body.

5. The display screen assembly of claim 4, wherein said first ventilation passageway increases in cross sectional area from said first inlet to said first outlet.

6. The display screen assembly of claim 4, further including a second ventilation passageway having a second inlet and a second outlet, said second outlet located at said first end of said elongated body.

7. The display screen assembly of claim 6, further including a third ventilation passageway having a third inlet and a third outlet, said third outlet located at said second end of said elongated body.

8. A motor vehicle assembly, comprising:
a windshield;
in instrument panel; and
a display screen assembly extending across a base of said windshield and atop of said instrument panel, said display screen assembly including an elongated body and a first ventilation passageway, in said elongated body, configured to distribute air from an HVAC system across said windshield.

9. The motor vehicle assembly of claim 8, wherein said elongated body includes a display screen, a close out panel and a support substrate between said display screen and said close out panel.

10. The motor vehicle assembly of claim 9, wherein said first ventilation passageway is at least partially formed in said support substrate.

11. The motor vehicle assembly of claim 10, wherein said first ventilation passageway includes a first inlet and a first outlet located intermediate a first end and a second end of said elongated body.

12. The motor vehicle assembly of claim 11, wherein said first ventilation passageway increases in cross sectional area from said first inlet to said first outlet.

13. The motor vehicle assembly of claim 12, further including a second ventilation passageway having a second inlet and a second outlet, said second outlet located at said first end of said elongated body.

14. The motor vehicle assembly of claim 13, further including a third ventilation passageway having a third inlet and a third outlet, said third outlet located at said second end of said elongated body.

15. The motor vehicle assembly of claim 14, wherein said instrument panel includes a first HVAC outlet in communication with said first inlet, a second HVAC outlet in communication with said second inlet and a third HVAC outlet in communication with said third inlet.

16. The motor vehicle assembly of claim 15, further including a first demister in a first A-pillar adjacent said windshield and a second demister in a second A-pillar adjacent said windshield, said first demister being in communication with said second outlet and said second demister being in communication with said third outlet.

17. A method of clearing a windshield of fog or ice above a full width display screen, comprising:
directing conditioned air from an HVAC system to a first HVAC outlet provided in an instrument panel beneath said full width display screen; and
directing said conditioned air from said first HVAC outlet through a first ventilation passageway behind a central portion of said full width display screen onto said windshield.

18. The method of claim 17, including:
directing said conditioned air from said HVAC system to a second HVAC outlet provided in said instrument panel beneath said full width display screen; and
directing said conditioned air from said second HVAC outlet through a first demister passageway behind a first end portion of said full width display screen and through a first demister in a first A-pillar adjacent said windshield.

19. The method of claim 18, including:
directing said conditioned air from said HVAC system to a third HVAC outlet provided in said instrument panel beneath said full width display screen; and
directing said conditioned air from said third HVAC outlet through a second demister passageway behind a second end portion of said full width display screen and through a second demister in a second A-pillar adjacent said windshield.
